(19) United States
(12) Patent Application Publication
(10) Pub. No.: US 2002/0197894 A1
(43) Pub. Date: Dec. 26, 2002

(54) Electrical connector

(75) Inventors: Takeshi Konno, Ibaraki (JP); Sukegawa Akihito, Ibaraki (JP); Shinichi Asano, Ibaraki (JP)

Correspondence Address: DARBY & DARBY P.C., P. O. BOX 5257, NEW YORK, NY, 10150-5257, US

(73) Assignee: Mitsumi Electric Co., Ltd.

(21) Appl. No.: 10/109,618

(22) Filed: Mar. 27, 2002

(30) Foreign Application Priority Data
Mar. 27, 2001 (JP) 2001-091211

(51) Int. Cl. H01R 12/00

(52) U.S. Cl. 439/79

(57) ABSTRACT

An electrical connector includes a socket connector engagable with a plug connector. The plug connector slides into a recess of the socket connector and is securely guided and aligned with connection terminals during insertion. Complementary joining parts on the inside of the recess and the outer surface of the socket connector engage, prevent the socket connector from damaging the connection terminals in the recess, and securely guide the socket connector during insertion and reuse.

### BACKGROUND TO THE INVENTION

1. Field of the Invention

The present invention relates to an electrical connector that has a plurality of connection terminals. More particularly, the present invention relates to an electrical connector with an improved alignment feature for employment in reliably connecting audio devices, such as car radios.

2. Description of the Related Art

Referring now to FIGS. 7 and 8, an electrical connector 1 includes a plug connector 3 mounted on a substrate 2, and a socket connector 4, which inserts into plug connector 3 to establish an electrical connection therebetween.

Plug connector 3 has a plug connector body 3a and a plurality of connection terminals 3b securely embedded in plug connector 3a.

Plug connector body 3a has a recess 3c which opens at an end surface thereof. Plug connector body 3a has a locking part 3d that protrudes downward from a lower surface of plug connector body 3a. Locking part 3d aids in positioning and temporarily retaining plug connector body 3a with respect to substrate 2.

Connection terminals 3b are arranged in two rows at a fixed interval in plug connector body 3a. One end of connection terminals 3b protrudes in a socket connector insertion direction inside recess 3c of plug connector body 3a. The other end of connection terminals 3b passes through plug connector body 3a and is exposed on the lower surface of plug connector body 3a. The other end of each connection terminal 3b is electrically connected by soldering to a connecting land (not shown) formed on the surface of substrate 2.

Referring now to FIGS. 9 through 12, socket connector 4 includes a socket connector body 4a and a plurality of connection terminals 4b embedded in socket connector body 4a.

Socket connector body 4a has a plurality of joining holes 4c which open on an end surface thereof allowing plug connection terminals 3b access to socket connection terminals 4b, during an assembly process.

Connection terminals 4b are arranged in two rows in the same manner as connection terminals 3b of socket connector 3. During careful assembly, socket connector body 4a of socket connector 4 is inserted inside recess 3c on plug connector body 3a of plug connector 3, one end of each connection terminal 3b fits inside each respective joining hole 4c of socket connector body 4a.

As a consequence of this contact between connection terminal 3b and connection terminal 4b of socket connector 4, an electrical connection is achieved linking socket connector 4 to substrate 2.

During normal assembly and use, after mounting plug connector 3 onto substrate 2, socket connector body 4a of socket connector 4 is inserted inside recess 3c of plug connector 3.

Once socket connector body 4a is completely pushed inside recess 3c, each connection terminal 3b of plug connector 3 contacts each of the corresponding connection terminal 4b of socket connector 4, and connection of socket connector 4 and plug connector 3 is achieved.

As can be seen from this design, during proper insertion, the outer surface of socket connector body 4a is restricted in the direction perpendicular to the insertion direction by the inner wall of recess 3c of plug connector body 3a.

Unfortunately, as shown by the tilted position A of socket connector body 4a in FIG. 7, when socket connector body 4a is inserted at a mis-aligned angle in the vertical direction with respect to recess 3c of plug connector 3, a lower end edge of socket connector body 4a contacts the end of connection terminals 3b of plug connector 3.

As a consequence, should socket connector body 4a be further inserted in an effort to achieve electrical connection, connection terminals 3b of plug connector 3 are bent, deformed, and may be broken. Resulting in undesirable equipment damage and expensive and costly repairs.

### OBJECT AND SUMMARY OF THE INVENTION

It is an object of the present invention to provide an electrical connector in which straight and non-damaging insertion is ensured by simple construction.

The present invention relates to an electrical connector having a socket connector engagable with a plug connector. The plug connector slides into a recess of the socket connector and is securely guided and aligned with connection terminals during insertion. Complementary joining parts on the inside of the recess and the outer surface of the socket connector engage, prevent the socket connector from damaging the connection terminals in the recess, and securely guide the socket connector during insertion and reuse.

According to an embodiment of the present invention, there is provided an electrical connector, comprising: a socket connector, a socket connector body and a plurality of socket connection terminals in the socket connector, the socket connector body including a plurality of joining holes, the joining holes communicating respectively between first ends of each the socket connection terminal and a first face of the socket connector body, at least a first joining part on a first outer wall surface of the socket connector body, at least a second joining part on a second outer wall surface of the socket connector body, a plug connector, a plug connector body and a plurality of plug connection terminals in the plug connector, the plug connector body including a recess on a back end of the plug connector body, second ends of each the plug connection terminals extending into the recess toward the back end, the second ends of each the plug connection terminal insertably aligned with respective the joining holes and the socket connection terminals, at least a third joining part on a first inner wall surface of the recess, at least a fourth joining part on a second inner wall surface of the recess, and the first and second joining parts positively engaging, and preventing a misalignment of the socket connector with the plug connector, by aligning with respective the third and fourth joining parts during an insertion of the socket connector body into the recess, thereby preventing damage to the plug connection terminals and enabling easy electrical connection between the plug connection terminals and respective the socket connection terminals.

According to another embodiment of the present invention, there is provided an electrical connector, wherein: the at least first and second joining parts on the socket connector body are first and second guide ribs, and the at least third and fourth joining parts on the plug connector body are at least third and fourth guide grooves, whereby the guide ribs positively engages and slides along the guide grooves during the insertion and prevents the misalignment.

According to another embodiment of the present invention, there is provided an electrical connector, wherein: the at least first and second joining parts on the socket connector body are first and second guide grooves, and the at least third and fourth joining parts on the plug connector body are at least third and fourth guide ribs, whereby the guide grooves positively engages and slides along the guide ribs during the insertion and prevents the misalignment.

According to another embodiment of the present invention, there is provided an electrical connector, wherein: the at least first and second joining parts are at least one of a guide groove and a guiding rib, and the at least third and fourth joining parts are the other of the at least one of guide groove and the guide rib, whereby the at least one positively engages respective the other during the insertion and prevents the misalignment.

According to another embodiment of the present invention, there is provided an electrical connector, wherein: the guide grooves extend parallel to the plug connection terminals, the guide ribs extend parallel to the plug connection terminals, the guide grooves aligned with at least one of the plug connection terminals, and the guide ribs aligned with at least one of the plug connection terminals, whereby the joining parts maximize an insertion force during the insertion along the plug connection terminals and ensure a secure joining.

The above, and other objects, features, and advantages of the present invention will become apparent from the following description read in conjunction with the accompanying drawings, in which like reference numerals designate the same elements.

### BRIEF DESCRIPTION OF THE FIGURES

FIG. 1 is a partial cross-section showing the structure of an embodiment of an electrical connector.

FIG. 2 is a front view of a plug connector of FIG. 1.

FIG. 3 is a cross-section taken along line I-I of the plug connector of FIG. 2.

FIG. 4 is a front view of a socket connector FIG. 1.

FIG. 5 is a side view of the socket connector of FIG. 4.

FIG. 6 is a cross-section taken along line II-II of the socket connector of FIG. 4.

FIG. 7 is a cross-section of one embodiment of an electrical connector of the related art.

FIG. 8 is a front view of a plug connector of FIG. 7.

FIG. 9 is a cross-section taken along line III-III of the plug connector of FIG. 8.

FIG. 10 is a front view of a socket connector of FIG. 7.

FIG. 11 is a side view of the socket connector of FIG. 10.

FIG. 12 is a cross-section taken along line IV-IV of FIG. 10.

### DESCRIPTION OF THE PREFERRED EMBODIMENTS

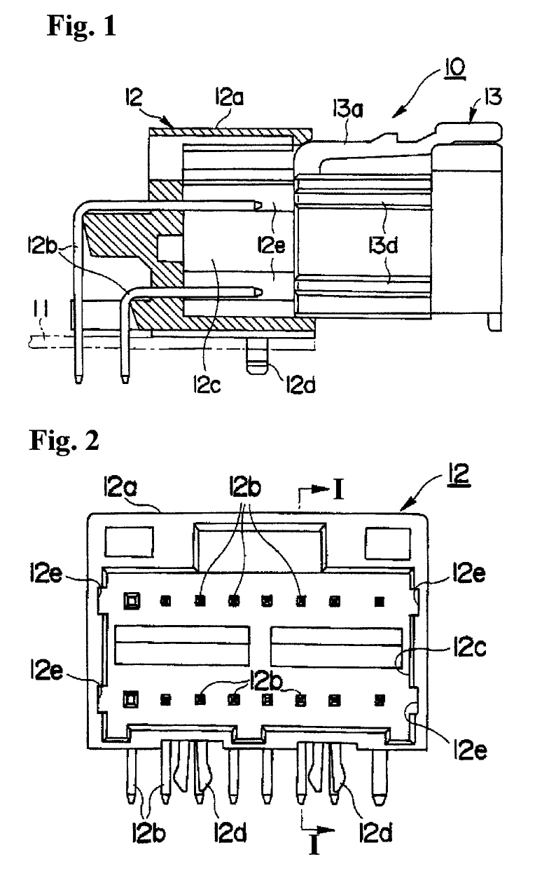

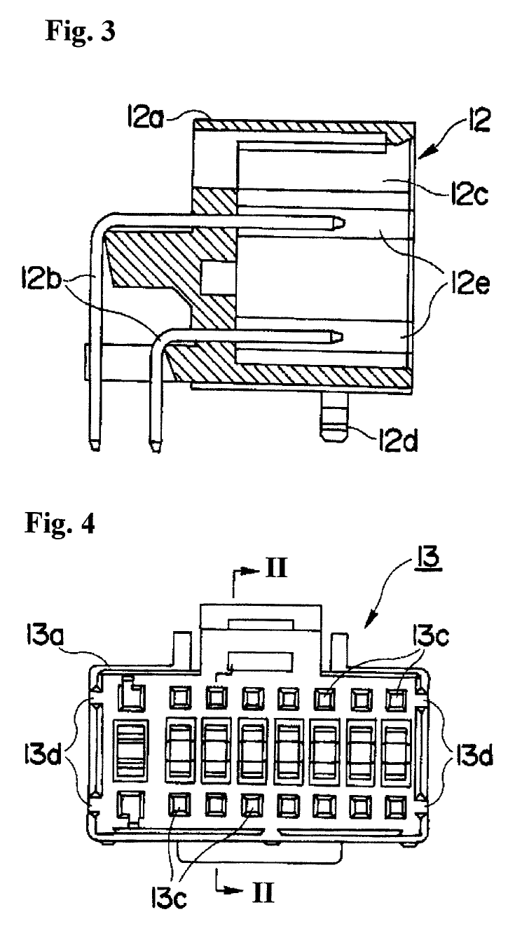

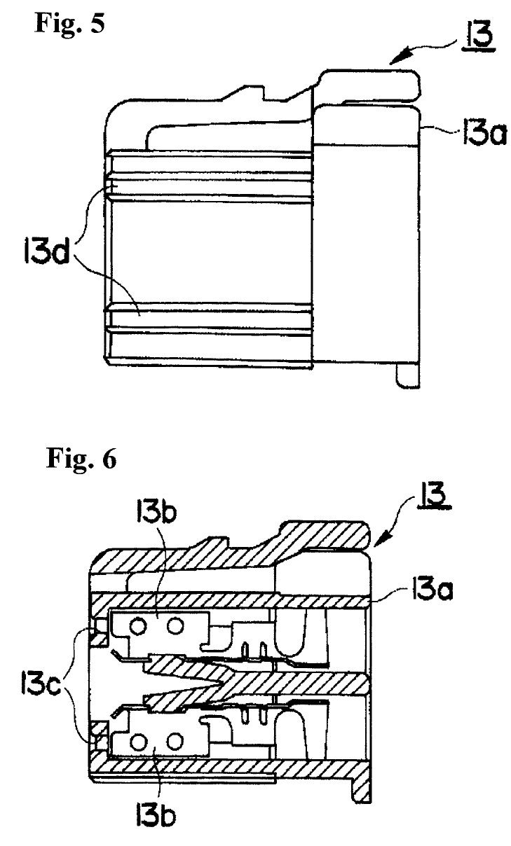

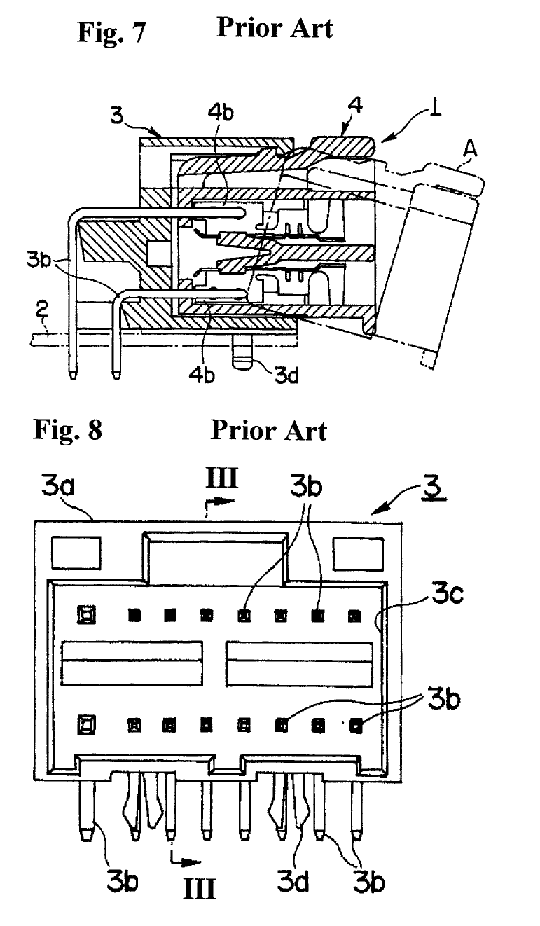

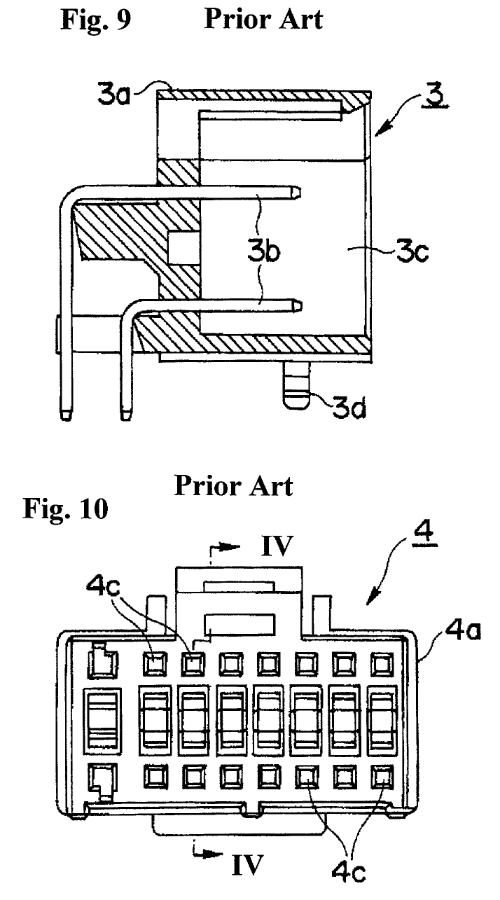

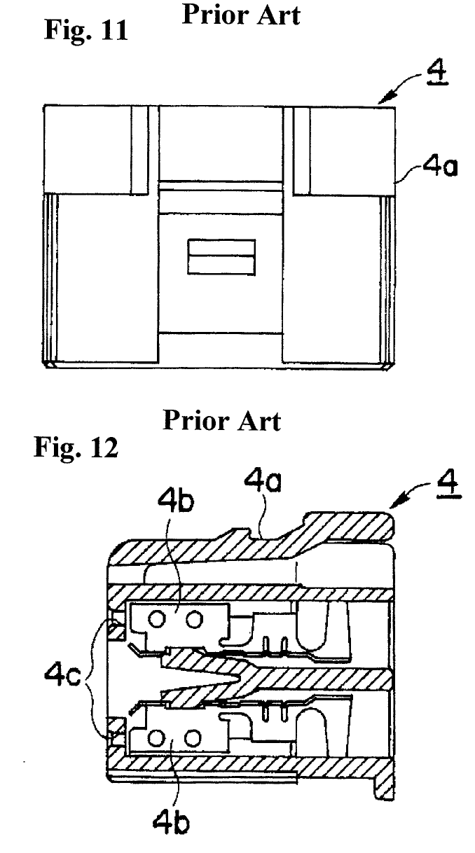

Referring to FIGS. 1 through 6, an electrical connector 10 includes a plug connector 12, mountable onto a substrate 11, and a socket connector 13 guidably insertable into plug connector 12, as will be explained.

A plug connector body 12a includes a plurality of connection terminals 12b securely embedded in plug connector body 12a.

A recess 12c in plug connector body 12a opens at an end surface for operable and guided receipt of socket connector 13 during use, as will be explained.

A locking part 12d extends away from plug connector body 12a and engages substrate 11, during assembly. Locking part 12d, operates to provide an operably secure attachment to substrate 11.

Connection terminals 12b are arrayed in plug connector body 12a in two rows. A first end of each connection terminal 12b protrudes inside recess 12c of plug connector body 12a, as shown. A second end of each connection terminal 12b, passes securely through plug connector body 12a, and extends away from a bottom surface of plug connector body 12a toward substrate 11.

During assembly, the second end of each connection terminal 12b extends to and electrically contacts with respective connection lands (not shown) formed on substrate 11. Each second end of respective connection terminals 12b is soldered to respective lands (not shown) and provides a secure electrical connection between plug connector 12 and substrate 11.

Socket connector body 13a has a plurality of connection terminals 13b which are embedded into socket connector body 13a.

Socket connector body 13a is equipped with a plurality of joining holes 13c which extend from an end surface of socket connector body 13a to an interior of said socket connector body 13 a and allow access by the first ends of connection terminals 12b to socket connector terminals 13b, as will be explained.

A connection terminal 13b are housed inside respective joining hole 13c of socket connector body 13a. In the present embodiment, connection terminals 13b are arranged in two rows positioned to engage respective connection terminals 12b of plug connector 12.

During assembly, when socket connectorbody 13a is inserted inside recess 12c on plug connector body 12a, one end of connection terminals 12b of socket connector body 12a extends inside each joining hole 13c of socket connector body 13a and contacts connection terminal 13b to provide electrical connection therethrough.

A plurality of guide grooves 12e are on opposite inside surfaces of recess 12c in plug connector body 12a. Guide grooves 12e are joining parts or joining means that extend along the insertion direction of socket connector 13.

A plurality of guide ribs 13d are on both outside surfaces of socket connector body 13a. Guide ribs 13d are also joining parts or joining means and extend along the insertion direction of socket connector 13 corresponding to guide grooves 12e.

As presently shown, there are two vertically separated guide grooves 12e and guide ribs 13d on each side of respective plug connector body 12a and socket connector body 13a.

In the embodiment shown, positions and heights of guide grooves 12e and guide ribs 13d correspond to the heights of the two rows of connection terminals 12b and connection terminals 13b of socket connector 13.

Guide grooves 12e receive and positively engage guide ribs 13d and mandate alignment of socket connector body 13a with plug connector body 12a during an insertion into recess 12c.

At the beginning of the insertion process, before possible damage to the ends of connection terminals 12b, guide ribs 13d initially engage and slide into respective guide grooves 12e. Since there are two vertically aligned sets of guide grooves/guide ribs, vertical and horizontal misalignment of socket connector body 13a relative to plug connector body 12a, is prevented. Since vertical and horizontal misalignment is prevented, damage to connection terminals 12b is correspondingly prevented, even during repeated insertion and disengagement actions.

During a middle of the insertion process, guide ribs 13d engage guide grooves 12e and align and guide initial engagement between joining holes 13c and respective connection terminals 12b. At this time ends of connection terminals 12b initially enter joining holes 13c and do not, as yet, contact connection terminals 13b.

During the end of the insertion process the ends of connection terminals 12b positively engage respective connection terminals 13b in an alignment matter and provide electrical connection therethrough.

As a benefit of the present embodiment, even where socket connector 13 is initially pushed into recess 12c at an angle with respect to plug connector 12, guide ribs 13d and guide grooves 12e reposition and straighten the insertion direction and prevent damage to connection terminals 12b.

As an additional benefit, since guide grooves 12e and guide ribs 13d are provided at the same height as connection terminals 13b and connection terminals 12b, connection terminals 13b of the socket connector and connection terminals 12b of the plug connector are connected smoothly as alignment force beneficially operates along the direction of positive engagement.

As a consequence of the present invention, socket connector 13 is never inserted into plug connector 12 at an angle and there is no danger of connection terminals 12b being bent, deformed, or broken by the end edge of socket connector body 13a. As a result, a highly reliable electrical connector 10 is achieved for a manufacturer and user of the present invention.

With the above-described embodiment, socket connector 13 has guide ribs 13d and plug connector 12 has guide grooves 12e as respective joining parts for the socket connector and plug connector. However, it should be understood, that the present invention is not limited to the above-described embodiment, and in a reverse embodiment, socket connector 13 could have guide grooves, and plug connector 12 could have the guide ribs. The joining parts could have other suitable shapes which mutually engage and maintain alignment between the parts involved.

Connection terminals 12b protrude downward from the lower surface of plug connector body 12a, but may alternatively protrude from another surface of plug connector 12a, where a substrate 11 would be alternatively, or additionally attached.

As described above, according to the present invention, when a socket connector is connected with a plug connector, a joining part that is provided on the outer surface of a socket connector body and is preferably a guide rib or a guide groove which joins with a joining part that is provided on the inner surface of a recess of the plug connector body and is preferably a respective guide groove or a guide rib. The design of the present embodiment of the socket connector is guided straight in the insertion direction with respect to the plug connector.

When the joining part on the socket connector is guided by the joining part of the plug connector, the socket connector is not at an angle with respect to the plug connector, and they are guided together in a straight manner. As a result, the socket connector body does not contact the connection terminals and bending deformation or breaking resulting from the slanted insertion does not occur. Consequently, a reliability of the electrical connector is improved with a construction which is simple and is cost effective to produce.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the spirit and scope of this invention as defined in the following claims. In the specification above or claims below, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies entirely on friction between a wooden part and a cylindrical surface, a screw's helical surface positively engages the wooden part, and a bolt's head and nut compress opposite sides of at least one wooden part, in the environment of fastening wooden parts, a nail, a screw, and a bolt may be readily understood by those skilled in the art as equivalent structures.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An electrical connector, comprising:
a socket connector;
a socket connector body and a plurality of socket connection terminals in said socket connector;
said socket connector body including a plurality of joining holes;
said joining holes communicating respectively between first ends of each said socket connection terminal and a first face of said socket connector body;
at least a first joining part on a first outer wall surface of said socket connector body;
at least a second joining part on a second outer wall surface of said socket connector body;
a plug connector;
a plug connector body and a plurality of plug connection terminals in said plug connector;
said plug connector body including a recess on a back end of said plug connector body;
second ends of each said plug connection terminals extending into said recess toward said back end;
said second ends of each said plug connection terminal insertably aligned with respective said joining holes and said socket connection terminals;
at least a third joining part on a first inner wall surface of said recess;
at least a fourth joining part on a second inner wall surface of said recess; and
said first and second joining parts positively engaging, and preventing a misalignment of said socket connector with said plug connector, by aligning with respective said third and fourth joining parts during an insertion of said socket connector body into said recess, thereby preventing damage to said plug connection terminals and enabling easy electrical connection between said plug connection terminals and respective said socket connection terminals.

2. An electrical connector, according to claim 1, wherein:
said at least first and second joining parts on said socket connector body are first and second guide ribs; and
said at least third and fourth joining parts on said plug connector body are at least third and fourth guide grooves, whereby said guide ribs positively engages and slides along said guide grooves during said insertion and prevents said misalignment.

3. An electrical connector, according to claim 1, wherein:
said at least first and second joining parts on said socket connector body are first and second guide grooves; and
said at least third and fourth joining parts on said plug connector body are at least third and fourth guide ribs, whereby said guide grooves positively engages and slides along said guide ribs during said insertion and prevents said misalignment.

4. An electrical connector, according to claim 1, wherein:
said at least first and second joining parts are at least one of a guide groove and a guiding rib; and
said at least third and fourth joining parts are the other of said at least one of guide groove and said guide rib, whereby said at least one positively engages respective said other during said insertion and prevents said misalignment.

5. An electrical connector, according to claim 4, wherein:
said guide grooves extend parallel to said plug connection terminals,
said guide ribs extend parallel to said plug connection terminals,
said guide grooves aligned with at least one of said plug connection terminals; and
said guide ribs aligned with at least one of said plug connection terminals, whereby said joining parts maximize an insertion force during said insertion along said plug connection terminals and ensure a secure joining.
